(19) United States
(12) Patent Application Publication
(10) Pub. No.: US 2026/0356047 A1
(43) Pub. Date: Nov. 12, 2026

(54) METHOD FOR CONNECTING CONNECTION REGIONS MADE OF SILICONE

(71) Applicants: Hochschule für angewandte Wissenschaft und Kunst Hildesheim/Holzminden/Göttingen, Hildesheim (DE); Sartorius Stedim FMT, Aubagne (FR)

(72) Inventors: Christian Ochs, Bovenden (DE); Martin Bellmann, Witzenhausen (DE); Wolfgang Viöl, Adelebsen (DE); Bernd Schieche, Göttingen (DE); Johannes Wortmeyer, Göttingen (DE); Ralf Lausch, Göttingen (DE)

(21) Appl. No.: 19/713,000

(22) Filed: Jun. 18, 2026

Related U.S. Application Data
(63) Continuation of application No. PCT/EP2024/086508, filed on Dec. 16, 2024.

(30) Foreign Application Priority Data
Dec. 20, 2023 (EP) 23 218 447.3

(51) Int. Cl. B29C 65/14; B29C 65/48; B29K 83/00; B29L 23/00

(52) U.S. Cl. CPC B29C 65/1406; B29C 65/48; B29K 2083/00; B29L 2023/00

(57) ABSTRACT

The invention relates to a method for connecting a first connection region (6a) to a second connection region (6b). The connection regions (6a, 6b) are made of silicone. In order to produce a connection of the connection regions (6a, 6b), they are exposed to VUV radiation (7). Simultaneously therewith or subsequently thereto, the connection regions (6a, 6b) are pressed against one another. The method according to the invention may be used for the end-face connection of two silicone tubes, for the connection of an inner surface of a silicone tube to a lateral surface of a connection stub made of silicone, or for the production of a sealed closure of a silicone tube, which may then be severed in order to provide two sealed, closed silicone tube sections.

### CROSS REFERENCE TO RELATED APPLICATIONS

This application is a continuation of International Application PCT/EP2024/086508 with an international filing date of Dec. 16, 2024 and claiming priority to co-pending European Patent Application No. 23 218 447.3 entitled “Verfahren zum Verbinden von Verbindungsbereichen aus Silikon”, filed on Dec. 20, 2023.

### FIELD OF THE INVENTION

The invention relates to a method for connecting a first connection region of a first object to a second connection region of a second object or of the first object, wherein the connection regions are made of silicone.

A connection of connection regions made of silicone is required, for example, in objects, in particular products, in medical technology or in the construction, automotive, electrical or electronics industries.

“Silicone” refers to poly(organo)siloxanes, which are a group of synthetic polymers in which silicon atoms are linked via oxygen atoms. The silicones may have molecular chains or molecular networks. It is possible that remaining free valence electrons of the silicon are saturated by hydrocarbon radicals (in particular methyl groups). Silicones therefore belong to the group of silicium-organic connections. The silicones may consist of individual siloxane units in which the silicon atoms, which do not achieve their octet by forming bonds to oxygen, are saturated with organic radicals. The silicones comprise cyclic polysiloxanes, linear polysiloxanes, branched polysiloxanes, cross-linked polysiloxanes. Silicones may have different substituents bonded to the silicon. The siloxane framework may contain various hydrocarbons, wherein silicon-functional and organofunctional groups may be present.

For example, the silicone relevant here may be silicone rubber or a silicone elastomer. Silicone rubbers contain, for example, poly(organo)siloxanes which have additional groups for cross-linking reactions, which may be hydrogen atoms, hydroxyl groups and vinyl groups, which may be located at the chain ends or may also be incorporated into the chain. The silicone rubbers may contain reinforcing substances and fillers, the type and quantity of which influence the mechanical and chemical behavior of the silicone elastomers formed by the cross-linking. The silicone rubbers may be cold-linked (“RTV silicone rubbers”) or hot-linked (“HTV silicone rubbers”). Another cross-linking mechanism of silicone rubbers may consist in the addition (catalyzed for example by noble-metal compounds of Si—H groups to silicon-bound vinyl groups, which may be incorporated into the polymer chains or at their ends. In the case of RTV silicone rubbers, one-component and two-component systems may be used.

Furthermore, the silicone may be formed as a silicone resin, which may be cross-linked polymethylsiloxanes or polymethylphenylsiloxanes. The silicone resins may also be combined with organic resins, for example alkyd resins, epoxy resins, melamine resins, phenolic resins and polyester resins. Silicone combination resins are also copolymers of low-molecular-weight, hydroxyl-functional silicones with polyesters, alkyd resins and acrylic resins.

Further embodiments of silicones are fluorosilicones and highly transparent silicones.

### BACKGROUND OF THE INVENTION

The publication
T. Yamamoto: “Solid-state bonding of silicone elastomer to glass by vacuum oxygen plasma, atmospheric plasma, and vacuum ultraviolet light treatment” Surface and Interface, Analysis 45 (2013) 817-822
   investigates the possibilities of connecting a silicone elastomer to glass, wherein a surface modification of the silicone elastomer by means of oxygen plasma, atmospheric-pressure plasma and VUV radiation is carried out here in the connection region. The VUV radiation was applied to a surface of the silicone elastomer in the connection region in the atmosphere at a distance of 3 mm, wherein a radiation with 30 mW/cm² at room temperature (25° C.) was carried out. The materials Sylpot 184 (Dow Corning Corp.), SIM 240, SIM 260 and X-32-3094-2 (Shin-Etsu Chemical Co., Ltd.) were used as silicone elastomers. In order to measure the surface modification brought about, contact angle measurements with a water droplet arranged on the surface of the treated silicone elastomer, measurements of changes in material behavior over time, and strength measurements of the created connection between the silicone elastomer and a glass plate were carried out. For the strength measurements, a mushroom-shaped specimen made of the silicone elastomer was used, the stem-side end face of which formed the connection region with the glass plate. After surface treatment of this end face, the end face was brought into contact with the glass plate within two minutes. Prior to carrying out the strength measurement, this contact was maintained for at least 24 hours in order to enable completion of the linking reaction. For the strength measurements, the connection thereby created was then subjected to a tensile force. The dependence of the achieved strength on the treatment duration was investigated. It was found that the strength is highest when treatment with VUV radiation is carried out for a period of a few seconds up to approximately 100 seconds.

The website
https://www.plastverarbeiter.de/verarbeitungsverfahren/silikone-ohne-klebstoff-fuegen.html
(“Joining silicones without adhesive”; date accessed: Jan. 8, 2022)
   proposes methods for adhesive-free connection of silicone materials to one another or to other materials such as aluminum, glass or steel. A material-bonded connection of the connection regions is intended to be achieved by radiating the surfaces and subsequently joining them, wherein the biocompatibility, temperature resistance and chemical resistance as well as the elastic properties of the silicone material are intended to be retained. Silicone materials are cited here in medical field as being used for catheters, prostheses, breathing masks, ventilation masks, valves in ventilators and all types of seals and tubes in medical devices. The website describes the problem that vulcanized silicones cannot simply be adhesively bonded. The reason stated is that silicone elastomers have a chemically inert surface with a surface energy that is at a comparable level to Teflon (PTFE). The low surface energy is unfavorable for wetting by adhesive. The absence of polar groups additionally has a limiting effect with regard to the required formation of reactive interactions between adhesive and substrate. The website describes that, for these reasons, physiologically and environmental-chemically questionable adhesion promoters are used for silicones in order to ensure sufficient adhesion. According to this website, basic compounds such as aliphatic amines, pyridine and imidazole derivatives are used to create an adhesion-resistant connection with a non-polar silicone rubber surface. The website proposes producing polar functional groups by activating treatment of the connection regions, which improve the adhesive properties. Reference is made to a research project (IGF project no.: 17551 N), in which it was demonstrated that silicone could be bonded without chemical adhesion promoters thanks to activating pretreatment. In contrast, the website proposes bonding silicones entirely without adhesive. For this purpose, irradiation of a connection region with VUV radiation is carried out. A Xe excimer lamp with emitted radiation having a wavelength of 172 nm is used as the radiation source. The radiation is intended to produce bond cleavages in the connection region. Through a subsequent reaction with oxygen, the connection region is then intended to be provided with reactive properties. If brought into contact in a suitable manner, material bonding may then occur with the formation of chemical bonds. Corresponding research work was carried out by Fraunhofer IFAM under the project title “Light-modified silicone materials for medicine and technology”. In the project, silicone Elastosil LR3004/40 from Wacker, Burghausen was used in the form of a plate material having a thickness of 2 mm, wherein this was platinum-catalyzed cross-linked silicone having a medium hardness of 40 Shore A. As inorganic joining partners, plated aluminum 2024, steel test specimens made of cold strip DC01 with a smooth, crack-free and pore-free surface, and glass test specimens made of Borofloat from Rocholl, Eschelbronn were used. After VUV irradiation of the connection regions of the silicone plate and of the inorganic joining partner, these were brought into contact with one another and subjected for a predetermined time to pressure and heating by means of a hot press at an elevated temperature. Subsequently, an investigation of the strength of the connection thereby created was carried out using a peel test based on DIN EN ISO 11339, and an investigation of the roughness of the joined parts by means of confocal microscopy was performed. Within the framework of the project, the power of the VUV radiation was varied, wherein irradiation took place under an air atmosphere and atmospheric pressure. It has shown that the strength of the produced connection remained unchanged independently of exposure of the connection to water and an elevated temperature of 180° C. over eight weeks. Pressing of the connection regions against one another took place at temperatures between 100° C. and 200° C., wherein pressures between 0.2 and 1.8 MPa were applied and the pressing duration was between 5 and 15 minutes. Since the connection was produced using a hot press, the method used in the project is not suitable for connecting three-dimensional objects. According to this website, the connection of three-dimensional objects is rather intended to be the subject of future research efforts.

The website
https://www.ifam.fraunhofer.e/de/technologien/vuv-strahlung-optimiert-silikoneigenschaften-an-der-oberflaeche.html
(“VUV Radiation Optimizes Silicone Properties at the Surface”; date accessed: Jan. 8, 2022)
   describes that silicones, which may be used in medical technology or food technology, are susceptible to wear and attract dirt and can only be bonded to a limited extent. A high coefficient of friction of a silicone elastomer, which is responsible for a high susceptibility to wear and complicates the assembly of silicone O-rings, for example, can be reduced by up to 90% by irradiating the surface with UV radiation, without impairing the otherwise positive mechanical properties of the silicones. Furthermore, irradiation of the surface with short-wave UV radiation leads to smoothing and hardening of the surface, which in turn results in reduced adhesion of dust and dirt particles. The website also mentions activation of connection regions of silicones by means of VUV radiation so that bonding with epoxy resins, polyurethane adhesives or adhesive tapes can take place, wherein chemical adhesion promoters can then also be dispensed with. Alternatively, the website proposes materially bonding VUV-activated silicone surfaces to one another without any adhesive. Such a connection is proposed in the so-called bond process for silicone joining parts in a homogeneous composite or in a heterogeneous composite with glass, aluminum or steel. The connections produced in this manner are intended to be resistant to aging and hydrolysis. Reference is made to IGF projects 17551 N, 18704 N and 19773 N, which concern the modification of silicone by means of UV light.

The website
https://www.sartorius.com/en/products/fluid-management/aseptic-disconnectors/biosealer-tube-sealer
(“Biosealer^{®}TC Aseptic Tube Sealing Device”; date accessed: Jan. 8, 2022)
   deals with sterile fluidic separations of thermoplastic tubes in biopharmaceutical manufacturing processes. A hand-held welding device is proposed into which a tube filled with a fluid is inserted. The tube is compressed between two jaws in such a manner that the fluid in the tube is displaced between the jaws and the tube is flattened between the jaws so that opposite inner surface regions of the tube come into contact with one another. By application of heat, the flattened portions of the tube are then welded together. After cooling, the tube can then be severed in the region of the flattened portion. In this manner, a fluid-tight and sterile end closure of the two tube pieces resulting from the severing can be produced.

Publication US 2018/0161554 A1 relates to a connection between an outer synthetic resin tube and an inner synthetic resin tube extending therethrough. The synthetic resin tubes may also comprise silicone resin or fluorine-containing silicone resin. The connected tubes are used for manufacturing a balloon catheter for medical applications. As a problem for such connections of synthetic resin tubes, US 2018/0161554 A1 describes that a connection should only be possible with corresponding synthetic resin materials of the two tubes. If an adhesive is used for the connection, undesirable hardening of the synthetic resin materials may occur, whereby the flexibility of the assembly consisting of the two tubes is reduced. It is proposed in US 2018/0161554 A1 that surface activation of the synthetic resin tubes is carried out by irradiating a surface with UV radiation. Plasma treatment of the connection region is also proposed. Before activation of the surface, the end regions of the outer synthetic resin tube are folded over to form a bead. In this state, the assembly formed by the inner synthetic resin tube and the outer synthetic resin tube with the folded-over beads is set into rotation, wherein the beads are then irradiated with UV radiation. The UV radiation is generated by means of a radiation source and has a wavelength of 200 nm or less. An excimer radiation source having a wavelength of 172 nm, a low-pressure mercury radiation source having a wavelength of 185 nm, or a deuterium radiation source having a wavelength in the range from 120 nm to 200 nm may be used, wherein the power may be 10 to 20 mW/cm². After irradiation, plasma treatment takes place. Subsequently, the folded-over end regions of the outer synthetic resin tube are folded back again so that the outer synthetic resin tube once returns into its original hollow-cylindrical shape. This has the consequence that the folded-back activated outer surfaces of the bead come into contact internally with the lateral surface of the inner synthetic resin tube, wherein a contact force in the range from 0.1 to 1.0 MPa may also be generated. In addition, heating of the connection regions may take place, wherein temperatures in the range from 100° C. to 200° C. may be used. Alternatively, US 2018/0161554 A1 proposes that the connecting end regions of the outer synthetic resin tube are first conically expanded, activated and then pressed against the outer surface of the inner synthetic resin tube under radial compression. Radial expansion of the inner synthetic resin tube in order to bring about pressing of the connection regions is also possible. Furthermore, activation of the surfaces for the connection by means of an electrode in an electrical discharge chamber is proposed, in which a gas is arranged that enables an electrical discharge.

US 2013/0037207 A1 discloses a connection of a block-shaped housing with a cover. Fine fluidic channels are formed in the housing and are closed by the cover. The microfluidic device thus formed is used for drug or pharmaceutical screening and DNA diagnostics. The housing and the cover are manufactured from silicone resin. The surface of the housing onto which the cover is to be applied is activated with VUV radiation, which may have an energy of 200 mJ/cm² to 1500 mJ/cm² and a wavelength of 172 nm. The cover is then pressed under pressure against the activated surface of the housing, whereby siloxane bonds are intended to result. Additionally, the surface of the housing may be activated by atmospheric plasma. The surface of the housing may also have protrusions with a height of several nanometers up to several hundred nanometers, which may be used as electrodes for measurements. The housing may be manufactured from a material that is permeable to VUV radiation. The cover consists of a substrate onto which silicone resin is dripped to form a connecting layer, with which the cover can be pressed onto the housing. This layer has a layer thickness of at most 10 μm. At this point in time, the synthetic resin layer is intended not yet to exert any adhesive effect. In order to ensure a kind of lubrication between the housing and the cover, methanol may also be applied to the contact surface of the synthetic resin layer. Subsequently, the connection region is irradiated with VUV radiation through the housing, which is permeable thereto. Through formation of an oxide film in the region of the contact surface, a connection of the cover to the housing is established.

EP 3 488 998 A1 (corresponding to U.S. Pat. No. 10,487,183 B2) discloses the production of a microchip for a microreactor for biochemistry. The microchip comprises a substrate with fine channels and may be manufactured from silicone or silicone resin. The microchip consists of two substrates connected to one another, which are plate-shaped and have a size of, for example, 85 mm×128 mm and a thickness of 1 mm to 3 mm. In an activation step, the surfaces of the substrates are exposed to VUV radiation and atmospheric plasma. In this process, VUV radiation having a wavelength of at most 200 nm, preferably 172 nm, is used, wherein the radiation intensity may be in the range of 10 to 100 mW/cm² and exposure of the substrates to the VUV radiation may take place for a period of 10 to 60 seconds. Subsequently, the substrates are stacked on one another such that the activated surfaces come into contact with one another. As a result of irregularities, for example having a wave-like shape in longitudinal section, intermediate spaces arise between the substrates. The substrates are pressed together with a pressing force in the range from 0.1 MPa to 5 MPa, for example for 60 to 300 seconds. In order to eliminate the intermediate spaces, the substrates are additionally heated, which leads to adaptation of the surfaces and thus to full-surface contact. The substrates may be connected to one another by triggered chemical reaction processes, in particular hydrogen bonding between OH groups of the substrates or covalent bonds resulting from dehydration condensation.

### SUMMARY OF THE INVENTION

The invention proposes a method for connecting a first connection region to a second connection region. In this case, the two connection regions may be assigned to different objects or to the same object. The connection regions are made of silicone.

The invention proposes a new method for connecting connection regions made of silicone, wherein the method is preferably used for connecting specific connection regions of at least one object.

In one embodiment, it is proposed that the first and/or the second connection region is/are exposed to VUV radiation. In this context, VUV radiation denotes vacuum-ultraviolet radiation having a spectral range of electromagnetic radiation. The spectral range of the VUV radiation is preferably in the range from 0.2 nm to 200 nm or 10 nm to 200 nm or in the range from 100 nm to 200 nm, wherein the wavelength is in particular between the spectral ranges of visible light and X-ray radiation. Preferably, the VUV radiation has a photon energy of at least 5 eV, preferably in the range from 6 eV to 6000 eV, and/or the VUV radiation is high-energy, ionizing radiation.

Preferably, an adhesive-free connection is produced and no adhesion promoter is used. In the case of a connection of the connection regions by means of clamps or other mechanical connections such as clip collars, crushing of the material occurs, which may lead to mechanical material damage that is undesirable and may, for example, lead to leakage or material failure. By the present embodiments, it is also possible to create a fluid-tight connection of the connection regions.

Preferably, the pressing of the connection regions against one another is maintained for less than one hour (for example 1 minute to 50 minutes or 5 minutes to 40 minutes), at least one hour, at least five hours, at least ten hours, at least 15 hours or even at least 24 hours. It is possible that implementation of the method and, in particular, exposure to the VUV radiation and/or pressing of the connection regions against one another is carried out under standard conditions, which includes the possibility that the method is carried out at 20° C. and 65% humidity.

For example, production of the connection between the connection regions may take place by cross-linking processes in the silicone.

The parameters of the method, in particular the distance of a VUV radiation source from a connection region, a power of the VUV radiation source, the wavelength of the VUV radiation and the pressing force or surface pressure for pressing the connection regions against one another, may be selected specifically depending on the type of objects to be connected and/or the materials of the connection regions (in particular the chemical composition and/or the structure).

It is possible that the connection regions are pressed against one another after the first and/or the second connection region has/have been exposed to VUV radiation. For this embodiment, preparation of the connection regions by exposure to VUV radiation takes place first, while subsequently contact between the connection regions is established, whereby the connection is then produced.

For another proposal, however, the connection regions are pressed against one another while they are exposed to VUV radiation. In this way, shortening of the connecting method may be achieved. On the other hand, it may prove advantageous if treatment of the connection regions with the VUV radiation takes place while they are pressed against one another.

In one embodiment, exposure of the first and/or second connection region takes place in the absence of oxygen. It is possible, for example, that the exposure takes place in a (technical) vacuum. However, it is also possible that exposure of the first and/or second connection region takes place in a chamber filled with an inert fluid. The inert fluid may, for example, be nitrogen.

In connection with the exposure of at least one connection region to VUV radiation and/or the pressing of the connection regions against one another, an elastic and/or plastic deformation of at least one object takes place in the at least one connection region. The deformation may take place before, during or after the exposure to VUV radiation and/or before, during and/or after pressing the connection regions against one another.

By means of the elastic and/or plastic deformation of at least one object in the connection region, various effects (to which the invention is not limited) may be achieved:
a) The elastic and/or plastic deformation may lead to a change in the geometry of the contact surface of the connection region.
   It is possible that this change in geometry ensures an enlarged contact surface.
   It is also possible that the change in geometry consists in a reduction in thickness. This change in thickness may lead to a connection whose extent transverse to the contact surface of the connection regions is reduced. However, the reduction in thickness may also advantageously be used so that particularly effective introduction of the VUV radiation can take place, under certain circumstances through the material in the connection region in the thickness direction.
   It is also possible that the elastic and/or plastic deformation may lead to a structural change in the material, with the result that the adhesive effect of the connection regions can be activated particularly effectively by means of the VUV radiation and/or the connection can be produced particularly well by pressing.
b) It is also possible that, in the case of elastic and/or plastic deformation, this deformation remains even after production of the connection. Thus, for example, a remaining elastic deformation may lead to tensioning of the objects relative to one another in the connection regions, which may positively influence the produced connection.

In one embodiment, the elastic and/or plastic deformation is brought about by means of a force-introduction body. In this case, the force-introduction body has a material region that is at least partially permeable or permeable to the VUV radiation, or the entire force-introduction body consists of a partially permeable or permeable material region. For example, such a force-introduction body or material region may be manufactured from quartz glass or magnesium fluoride. In this case, the force-introduction body is arranged between the object having the connection region and the radiation source in such a manner that the connection region is exposed to the VUV radiation from a VUV radiation source through the material region of the force-introduction body. It is possible, for example, that the force-introduction body is designed as a plate or block or another pressing body that exerts a normal stress on the object forming the connection region. For example, a quartz glass plate may be used, the thickness of which is less than 3 mm, is greater than 7 mm, or is in the range from 3 to 7 mm, preferably 4 to 6 mm. The force-introduction body designed in this manner enables, on the one hand, application of the force to the object for elastic and/or plastic deformation and simultaneously ensures transmission of the VUV radiation in order to bring about the desired modification of the connection region.

In principle, the connection regions may be formed by a single arbitrary object or by two arbitrary objects, wherein the one object or the two objects may consist of silicone only in the connection region or may consist entirely of silicone.

In one embodiment, the method is applied to an object forming a connection region, which is a hollow body having an interior space, which preferably has an opening to the outside. In this case, exposure of the connection region of this object may take place through the interior space, which may be the case alternatively or cumulatively with exposure of the object from the outside. It is thus possible that the VUV radiation source is mounted and oriented in such a manner that the VUV radiation enters the interior space through the opening of the interior space and there irradiates an inner surface delimiting the interior space, wherein this inner surface preferably forms the connection region. Alternatively, however, it is possible that the VUV radiation is transmitted from this inner surface outwardly through the object to an externally located connection region.

For another application of the method, a single silicone tube provides the first connection region and the second connection region, wherein these are provided by diametrically opposite inner surface regions that each extend approximately 180° in the circumferential direction and directly adjoin one another. During exposure of at least one of the connection regions to VUV radiation, an elastic and/or plastic deformation is then brought about by means of a force-introduction body in such a manner that the inner surface regions are flattened and brought into contact with one another. Furthermore, the force-introduction body may also bring about pressing of the inner surface regions against one another and, under certain circumstances, a further elastic and/or plastic deformation caused thereby, in particular a change in thickness. In this case, the force-introduction body has a material region at least partially permeable to the VUV radiation, in particular made of quartz glass or magnesium fluoride, and the connection regions to be exposed to the VUV radiation are exposed to the VUV radiation from a VUV radiation source through the material region of the force-introduction body. Such a method may even be carried out when the silicone tube is filled with a fluid. By connecting the opposite inner surface regions to one another, a fluid-tight closure of the silicone tube may be produced in the region of the created connection.

Preferably, the silicone tube is subsequently severed in the region of the connection regions, whereby two silicone tube sections that are fluid-tightly closed at their ends are created from the silicone tube.

For another proposed solution, the two connection regions are not connected directly to one another after their treatment with the VUV radiation. Rather, the connection regions (in particular in the case where they are formed by opposite inner surface regions of a silicone tube) define an intermediate space. An adhesive, any connecting means (for example in the form of a curable connecting fluid or pasty medium), or a connecting body may then be introduced into this intermediate space, which then establishes the connection with the connection regions treated by means of the VUV radiation.

In the case that the object is a silicone tube, an elastic and/or plastic deformation of the silicone tube may first take place by means of a force-introduction body in such a manner that the silicone tube is flattened, the inner surface regions of the silicone tube coming into contact with one another at the flattenings. In a subsequent method step, a separating location may then be produced by means of a separating tool, which separates silicone tube section parts from one another. Subsequently, a force-introduction body part is moved away from end regions of the silicone tube section parts. In these end regions, the intermediate spaces may then be formed, which may take place in particular by elastic recovery of the walls of the silicone tube section parts in the end regions or by additional measures. The inner surface regions are then exposed to VUV radiation in the region of the intermediate spaces adjoining the separating location by means of a radiation source. Subsequently, an adhesive, a connecting means, or a connecting body may be introduced into the intermediate spaces, which then establishes a connection with the inner surface regions.

It is possible that the methods explained are used for sealing a product filled with a fluid, for example a receiving container for a sterile product.

According to another proposed solution, a first object forming the first connection region is a first silicone tube, while a second object forming the second connection region is a second silicone tube. In this case, the connection regions are the respective end faces of the silicone tubes. Thus, for this embodiment, the end faces of the silicone tubes are first exposed to the VUV radiation. The two end faces are then pressed against one another so that a fluid-tight silicone tube string can be created from the two silicone tubes. For this purpose, the two silicone tubes preferably have identical inner and/or outer diameters or at least an overlapping diameter range.

For another proposed solution, a first object forming the first connection region is a silicone tube. In this case, the first connection region is an end-side inner surface of the silicone tube. A second object forming the second connection region has a fluidic connection stub. The fluidic connection stub has a lateral surface made of silicone, wherein the connection stub may consist entirely of silicone or a layer or sleeve made of silicone, which then forms the lateral surface, may be applied to the connection stub. In this case, the lateral surface forms the second connection region. After exposure of the first and/or second connection region to VUV radiation, the silicone tube is slipped over the connection stub, whereby the connection regions come into contact with one another and the adhesive connection and/or cross-linking takes place in the connection regions.

It is possible that, by means of clamping jaws or a temporary clamping collar or a pressing body, the silicone tube is pressed inwardly against the connection stub. For one proposal, the connection stub has an oversize relative to the silicone tube, so that, when slipping it on, elastic expansion of the silicone tube and/or radial compression of the connection stub must take place, which then ensures the pressing force of the connection regions against one another. The pressing force may then be defined by the extent of the oversize.

For this embodiment, exposure of the inner surface of the silicone tube to VUV radiation may take place through the interior space of the silicone tube.

VUV radiation having any wavelength or even a superposition of different wavelengths may be used. For a particular proposal, the VUV radiation has a wavelength of approximately 172 nm or 185 nm, wherein it is also intended to be encompassed that the wavelength may deviate by ±10%, ±5% or ±2% from the aforementioned wavelengths.

Advantageous developments of the invention result from the claims, the description and the drawings.

The advantages of features and of combinations of a plurality of features mentioned in the description only serve as examples and may be used alternatively or cumulatively without the necessity of embodiments according to the invention having to obtain these advantages.

The following applies with respect to the disclosure-not the scope of protection-of the application as filed and the patent: Further features may be taken from the drawings, in particular from the illustrated geometries and the relative dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims which, however, does not apply to the independent claims of the granted patent.

The number of the features mentioned in the claims and in the description is to be understood to cover this exact number and a greater number than the mentioned number without having to explicitly use the adverb “at least”. For example, if an element is mentioned, this is to be understood such that there is exactly one element or there are two elements or more elements. Additional features may be added to these features, or these features may be the only features of the respective product.

The reference numbers contained in the claims are not limiting the scope of protection of the claims. Their sole function is to make the claims easier to understand.

### BRIEF DESCRIPTION OF THE FIGURES

In the following, the invention is further explained and described with reference to preferred exemplary embodiments illustrated in the figures.

FIG. 1-3 show method steps of a method for connecting two objects, each of which is a silicone tube.

FIG. 4-6 show method steps of a method for connecting an object having a connection stub to a silicone tube.

FIG. 7-10 show method steps of a method by means of which two silicone tube sections are produced from a silicone tube, which may be filled with a fluid, wherein the silicone tube sections are fluid-tightly closed in the region of a separating location.

FIG. 11-15 show method steps of a further method by means of which two silicone tube sections are produced from a silicone tube, which may be filled with a fluid, wherein the silicone tube sections are fluid-tightly closed in the region of a separating location.

### DETAILED DESCRIPTION

In the following figures, the same reference sign is used in part for objects or features that correspond with regard to their design and/or function, wherein the objects or features may then be distinguished from one another by an additional letter a, b. Reference may then be made to these objects or features without use of the additional letter, whereby one object or one feature, several objects or features, or all objects or features having the reference numeral may be meant.

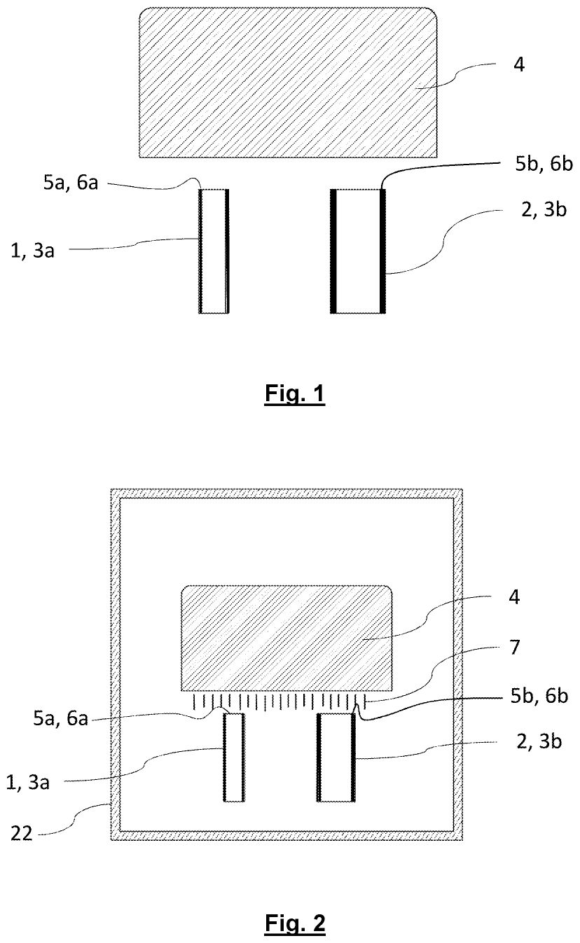

FIG. 1 shows a first object 1 and a second object 2, which are each designed as silicone tubes 3a, 3b. In this case, FIG. 1 merely schematically shows the end regions of the silicone tubes 3 that are to be connected. The silicone tubes 3 preferably have the same inner and outer diameters, wherein these may be manufactured from the same or different silicone materials.

According to FIG. 1, the silicone tubes 3 are arranged in the region of a VUV radiation source 4 in such a manner that a radiation region of the radiation source 4 is directed toward end faces 5a, 5b of the silicone tubes 3a, 3b. The end faces 5a, 5b form connection regions 6a, 6b, in the region of which the silicone tubes 3a, 3b are to be connected fluid-tightly and permanently to one another to form a silicone tube string.

In a subsequent method step shown in FIG. 2, the radiation source 4 is activated. This has the consequence that the connection regions 6a, 6b are exposed to VUV radiation 7. For the illustrated exemplary embodiment, the two end faces 5a, 5b are exposed simultaneously to the VUV radiation 7 from a common radiation source 4. It is likewise possible that one radiation source 4 exposes the connection regions 6a, 6b successively to VUV radiation 7, or that two radiation sources 4a, 4b are provided, each exposing an assigned connection region 6a, 6b to VUV radiation 7.

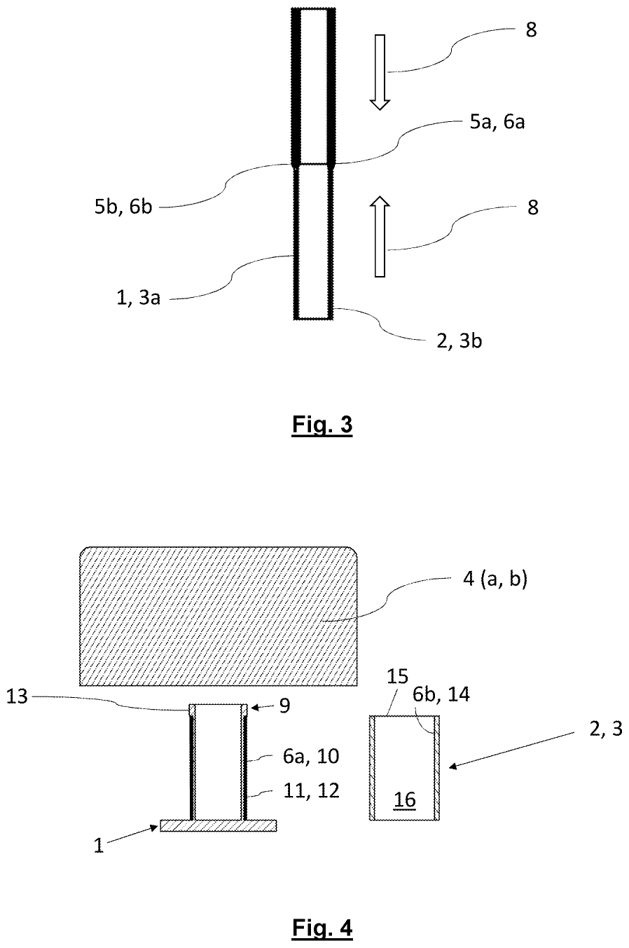

After such treatment of the connection regions 6a, 6b with VUV radiation 7 has taken place for a predetermined period of time, the connection regions 6a, 6b are pressed against one another with a pressing force 8, while the silicone tubes 3a, 3b are aligned coaxially, such that a flush inner and outer surface results (FIG. 3). The pressing force 8 is maintained for a predetermined period of time until a mechanically strong and fluid-tight connection between the silicone tubes 3a, 3b has been established.

For the method illustrated in FIGS. 4 to 6, the first object 1, which may for example be a housing part or cover part, has a connection stub 9. The connection stub 9 has a lateral surface 10 made of silicone. In this case, the lateral surface 10 may consist of a layer 11 made of silicone and surrounding a base body of the connection stub 9, or of a sleeve 12 made of silicone applied to the base body of the connection stub 9. Preferably, the connection stub has a shoulder 13 arranged in front of the lateral surface 10 made of silicone in the direction of the free end of the connection stub 9, the shoulder 13 securing the layer 11 or sleeve 12. In this case, the second object 2 is a silicone tube 3.

The two objects 1, 2 are first arranged according to FIG. 4 in the radiation region of a radiation source 4.

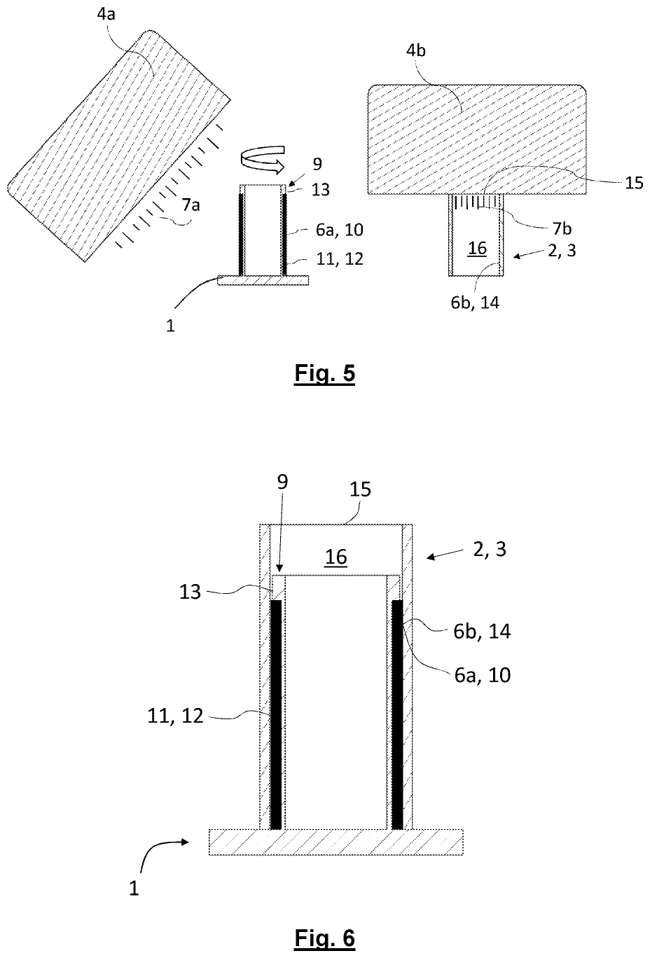

According to FIG. 5, both the lateral surface 10 of the connection stub 9 and an inner surface 14 of the silicone tube 3 are then exposed to VUV radiation 7. FIG. 5 illustrates a particular embodiment for exposure to the VUV radiation 7, although other configurations are also possible. Here, a radiation source 4a is arranged laterally next to the connection stub 9. The first object 1 is then set into rotation about the longitudinal axis of the connection stub 9, whereby the VUV radiation 7 of the radiation source 4a can expose the entire lateral surface 10. For exposure of the inner surface 14 of the silicone tube 3, a further radiation source 4b is used. The further radiation source 4b emits VUV radiation 7 through an opening 15 of the silicone tube 3 into an interior space 16 of the silicone tube 3 and then biases the inner surface 14 of the silicone tube 3. Deviating from the illustrated exemplary embodiment, it is even possible that the VUV radiation source 4b projects with a lance emitting the VUV radiation 7 through the opening 15 into the interior space 16 of the silicone tube 3.

After the lateral surface 10 of the connection stub 9 and of the inner surface 14 of the silicone tube 3 have been exposed to VUV radiation 7 for predetermined periods of time, the silicone tube 3 is slipped over the connection stub 9 according to FIG. 6. The lateral surface 10 of the connection stub 9 and the inner surface 14 of the silicone tube 3 thereby form a contact surface, such that they form the connection regions 6a, 6b. Preferably, the outer diameter of the lateral surface 10 has a larger diameter than the inner surface 14 of the silicone tube 3, whereby a pressing force in the connection regions 6a, 6b is ensured as a result of the required elastic radial deformation.

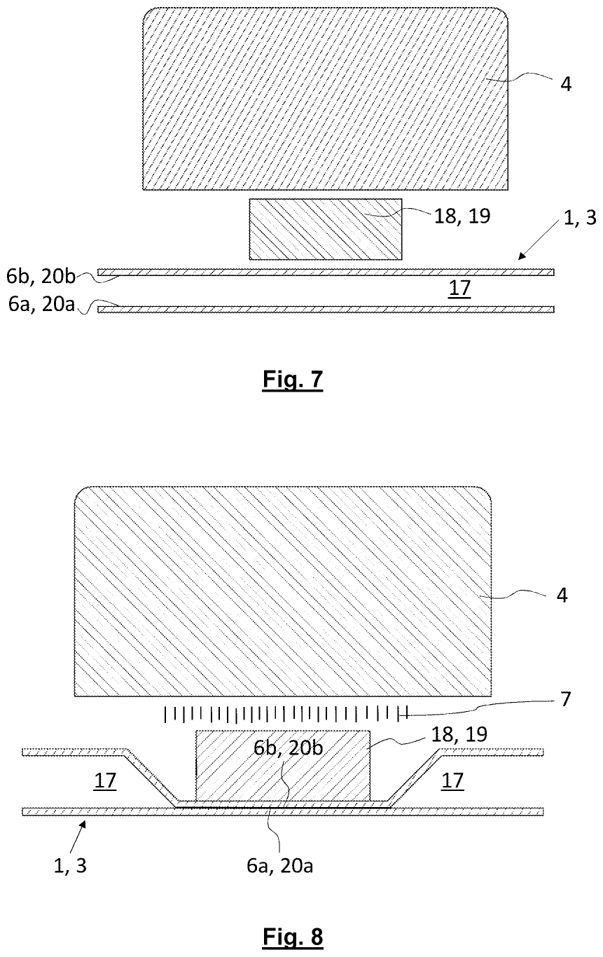

For the method illustrated in FIGS. 8 to 10, an object 1 is a silicone tube 3. The silicone tube 3 is preferably filled with a fluid 17. According to FIG. 7, a force-introduction body 18 is arranged between the silicone tube 3 and the radiation source 4. The force-introduction body 18 has at least one material region 19 made of a material that is permeable to VUV radiation 7.

According to FIG. 8, the force-introduction body 18 is pressed against the outer surface of the silicone tube 3 (for example by means of an actuator, manually, or as a result of its own weight). As a result of a pressing force of the force-introduction body 18 against the outer surface of the silicone tube 3, an elastic and/or plastic deformation of the silicone tube 3 takes place such that inner surface regions 20a, 20b opposite one another in the circumferential direction of the cross-section of the silicone tube 3 approach one another and are pressed against one another, whereby the cross-section of the silicone tube 3 is closed. During compression of the silicone tube 3 by the force-introduction body 18, the fluid is pressed laterally out of the intermediate space between the inner surface regions 20a, 20b. In the compressed state, exposure to the VUV radiation 7 takes place according to FIG. 8. In this case, the VUV radiation 7 passes from the radiation source 4 through the force-introduction body 18 and through the silicone tube 3 to the connection regions 6a, 6b formed by the inner surface regions 20a, 20b. The connection regions 6a, 6b are also exposed here to the VUV radiation 7 for a predetermined period of time. It is possible that, after the predetermined exposure period with the VUV radiation 7, the pressing of the force-introduction body 18 against the silicone tube 3 according to FIG. 8 is maintained for a further predetermined period of time.

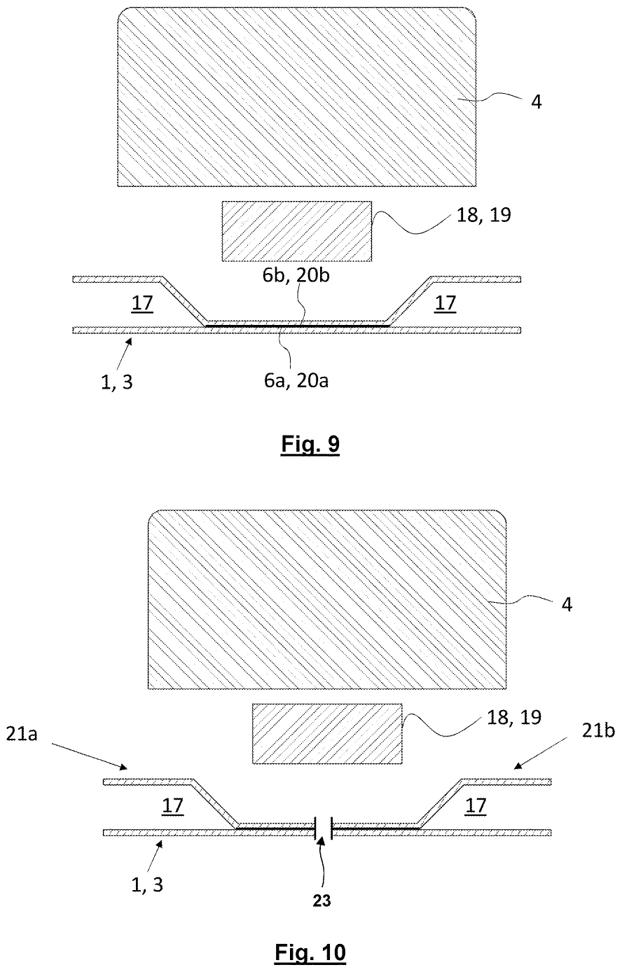

Subsequently, according to FIG. 9, the force-introduction body 18 is removed from the silicone tube 3. A permanent mechanical and fluid-tight connection between the connection regions 6a, 6b has been created.

According to FIG. 10, the silicone tube 3 may then be severed in the connection regions 6a, 6b, whereby two silicone tube sections 21a, 21b are produced, which are fluid-tightly closed in the illustrated end regions. The severing may take place, for example, by means of a cutting knife or by means of a laser. It is also possible that the force-introduction body 18 has a rib or cutting edge that causes weakening or severing when pressed against the silicone tube 3.

Insofar as reference is made in the present description to a silicone tube 3, this may be a silicone hose or a dimensionally stable but elastically or plastically deformable silicone tube.

It is possible that exposure of the connection regions 6a, 6b to VUV radiation 7 takes place in a chamber 22, as is illustrated schematically and by dashed lines in FIG. 1 by way of example. The chamber 22 may then be filled with an inert fluid, in particular nitrogen, or a technical vacuum may be produced in the chamber 22.

As described, the force-introduction body 18 may consist entirely, or only in a material region 19, of a material that is permeable to the VUV radiation 7. However, it is also possible that the force-introduction body has passage openings in the region of which the VUV radiation 7 passes through the force-introduction body 18 to the connection regions 6, while the force-introduction body 18 may also have material regions adjacent to these passage openings in which material is present that is not permeable to VUV radiation 7. For example, the force-introduction body 18 may be designed in the form of a grid or may be provided with a multiplicity of bores or recesses.

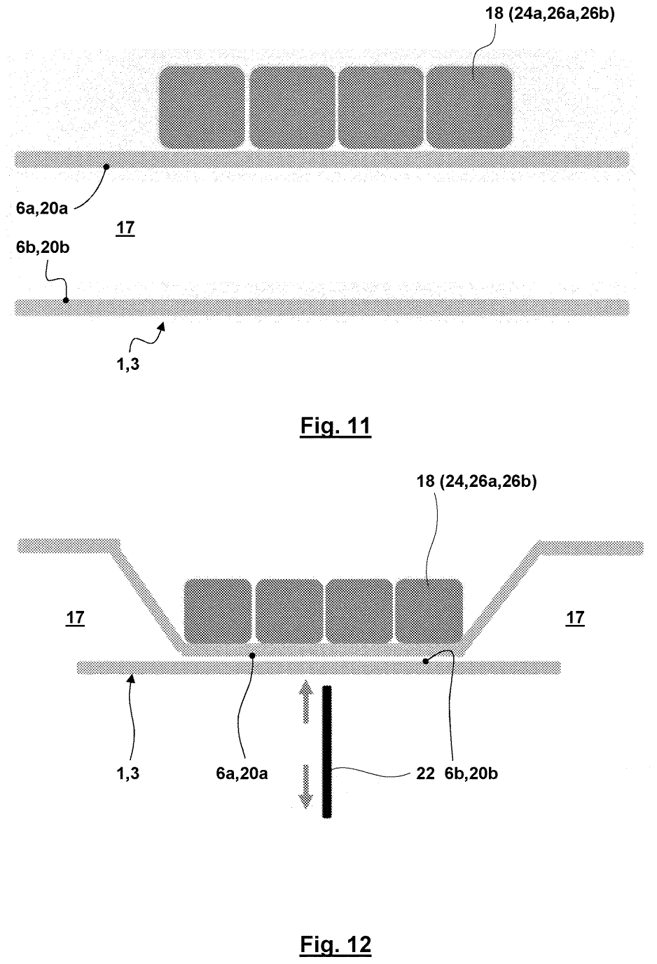

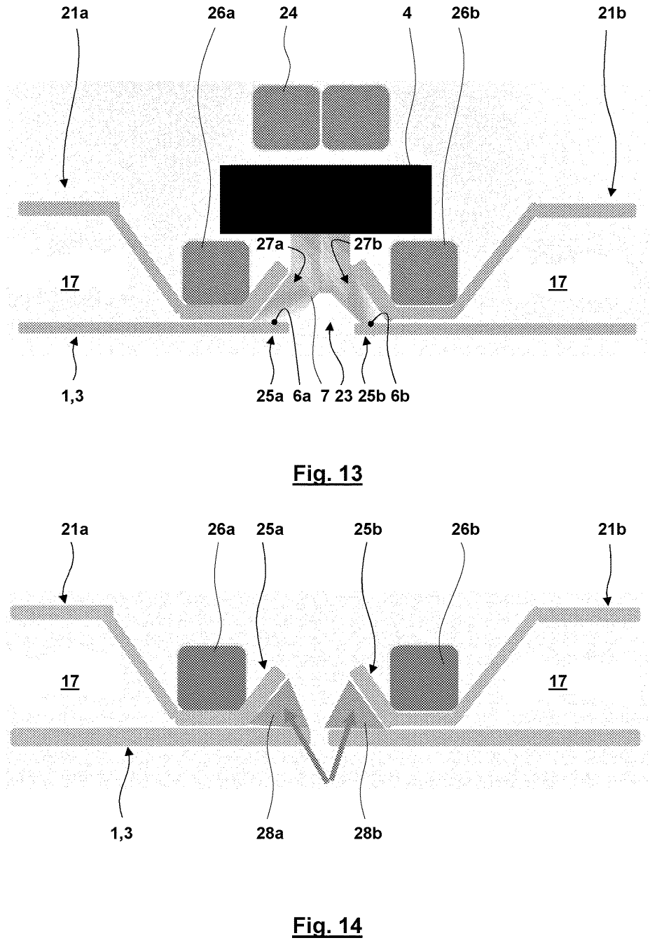

In FIGS. 11 to 15, an alternative method is illustrated by means of which a silicone tube 3 may be separated into two silicone tube sections 21a, 21b, each of which is fluid-tightly closed in the region of its separating location 23. Here too, according to FIG. 11, deformation of the silicone tube 3 first takes place by means of a force-introduction body 18 in such a manner that the inner surface regions 20a, 20b, which form the connection regions 6a, 6b, come into contact with one another (or at least have a reduced spacing from one another) (FIG. 12). For this exemplary embodiment, the force-introduction body 18 is designed in multiple parts. By means of a separating tool 22, the silicone tube 3 is then severed into the silicone tube sections 21a, 21b, creating a separating location 23 (cf. FIG. 13). A central force-introduction body part 24 is then moved away from the separating location 23 and the end regions 25a, 25b of the silicone tube sections 21a, 21b, while a section of the silicone tube sections 21a, 21b adjoining thereto continues to be pressed down and fixed by a respective force-introduction body part 26a, 26b. In the end regions 25a, 25b, the inner surface regions 20a, 20b may spread apart or move apart (in particular as a result of elastic recovery or as a result of internal stresses due to the preceding deformation), whereby, in particular according to FIG. 13, an intermediate space 27a, 27b is formed that is open in the direction of the separating location 23, and that may, for example, open in a wedge-shaped manner toward the separating location 23. By means of a radiation source 4, the inner surface regions 20a, 20b in the end regions 25a, 25b are then exposed to VUV radiation 7, wherein this VUV radiation 7 may reach the inner surface regions 20a, 20b through the end regions of the silicone tube sections 21a, 21b or (as illustrated in FIG. 13) through the opening of the intermediate spaces 27a, 27b.

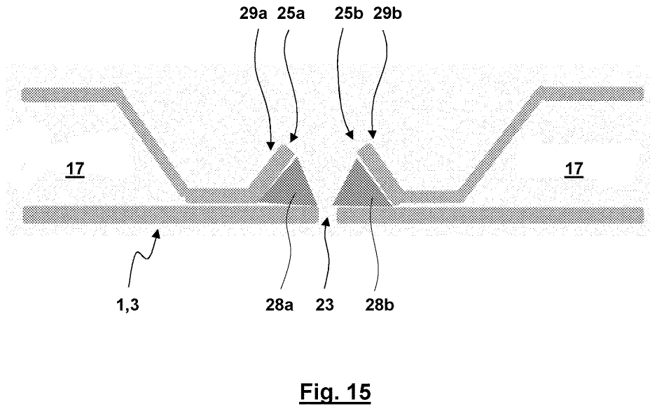

It is possible that, subsequently, the force-introduction body part 24 is moved downward again, whereby the end regions 25a, 25b are then also pressed against one another again for the purpose of producing the connection. FIG. 14, however, shows another embodiment of the method in which an adhesive, a connecting means, or a connecting body 28a, 28b is introduced into the intermediate spaces 27a, 27b, which then establishes the connection with the associated end region 25a, 25b of the silicone tube sections 21a, 21b (cf. FIG. 15). The end regions 25 together with the adhesive, connecting means, or connecting body 28 may each form a bead 29a, 29b.

Many variations and modifications may be made to the preferred embodiments of the invention without departing substantially from the spirit and principles of the invention. All such modifications and variations are intended to be included herein within the scope of the present invention, as defined by the following claims.

We claim:

1. A method for connecting a first connection region made of silicone to a second connection region made of silicone, the method comprising:
exposing at least one of the first and second connection regions to VUV radiation;
bringing the first connection region and the second connection region into contact with one another by pressing the first and second connection regions together or by introducing an adhesive, a connecting member, or a connecting body between the first and second connection regions; and
during exposure of at least one of the first and second connection regions to the VUV radiation, elastically or plastically deforming the at least one of the first and second connection regions by means of a force-application body;
wherein the force-application body comprises a material region that is at least partially permeable to the VUV radiation; and
the at least one of the first and second connection regions is exposed to the VUV radiation from a VUV radiation source through the material region of the force-application body.

2. The method of claim 1, wherein the connection regions are pressed together after exposure of at least one of the connection regions to the VUV radiation.

3. The method of claim 1, wherein the first and second connection regions are pressed together while at least one of the first and second connection regions is exposed to the VUV radiation.

4. The method of claim 1, wherein exposure of the at least one of the first and second connection region to the VUV radiation is performed in an oxygen-free environment.

5. The method of claim 4, wherein the oxygen-free environment is provided by a chamber containing an inert gas.

6. The method of claim 5, wherein the inert gas comprises nitrogen.

7. The method of claim 1, wherein at least one object forming one of the first and second connection regions comprises a hollow body defining an interior space, and the first or second connection region comprising the interior space is exposed to the VUV radiation through the interior space.

8. A method for connecting silicone surfaces, the method comprising:
providing a silicone tube having opposite inner surface regions defining first and second connection regions made of silicone;
deforming the silicone tube by means of a force-application body such that the opposite inner surface regions contact one another;
exposing at least one of the inner surface regions to VUV radiation during the deformation;
wherein the force-application body comprises a material region that is at least partially permeable to the VUV radiation; and
wherein the VUV radiation is transmitted from a VUV radiation source through the material region of the force-application body to the at least one inner surface region.

9. The method of claim 8, further comprising severing the silicone tube in a region of the connection regions after the connection regions have been connected to one another.

10. A method for connecting a first connection region made of silicone to a second connection region made of silicone, the method comprising:
exposing at least one of the first connection region and the second connection region to VUV radiation;
introducing an adhesive, a connecting member, or a connecting body between the first connection region and the second connection region,
wherein the first connection region and the second connection region are opposite inner surface regions of a silicone tube.

11. The method of claim 10, comprising:
deforming the silicone tube by means of a force-application body such that the opposite inner surface regions contact one another;
forming a separation location with a cutting tool such that two silicone tube section parts are separated from one another;
moving a force-application body part being a part of the force-application body away from end regions of the silicone tube section parts;
exposing the inner surface regions to VUV radiation in intermediate spaces adjacent the separation location; and
introducing the adhesive, connecting member, or connecting body into the intermediate spaces such that the adhesive, connecting member, or connecting body forms a connection with the inner surface regions.

12. The method of claim 10, wherein the silicone tube section parts are used for sealed fluid-filled products.

13. The method of claim 10, wherein the connection regions are brought into contact after exposure to the VUV radiation or during exposure to the VUV radiation.

14. The method of claim 10, wherein exposure to the VUV radiation is performed in an oxygen-free environment.

15. The method of claim 10, wherein at least one of the connection regions is elastically or plastically deformed before, during, or after exposure to the VUV radiation.

16. The method of claim 10, wherein at least one of the connection regions is defined by a hollow body having an interior space through which the VUV radiation is transmitted to the connection region.

17. A method for connecting a first connection region made of silicone to a second connection region made of silicone, the method comprising:
exposing at least one of the first connection region and the second connection region to VUV radiation;
bringing the first connection region and the second connection region into contact with one another;
wherein the first and second connection regions are provided by first and second silicone tubes; and
wherein the first and second connection regions are end faces of the first and second silicone tubes.

18. The method of claim 17, wherein the connection regions are brought into contact after exposure to the VUV radiation or during exposure to the VUV radiation.

19. The method of claim 17, wherein exposure to the VUV radiation is performed in an oxygen-free environment.

20. The method of claim 17, wherein at least one of the connection regions is elastically or plastically deformed before, during, or after exposure to the VUV radiation.

21. The method of claim 17, wherein at least one of the connection regions is defined by a hollow body having an interior space through which the VUV radiation is transmitted to at least one of the connection regions.

22. A method for connecting a first connection region made of silicone to a second connection region made of silicone, the method comprising:
exposing at least one of the first connection region and the second connection region to VUV radiation;
bringing the first connection region and the second connection region into contact with one another or connecting the first connection region and the second connection region by means of an adhesive, a connecting means or a connecting body;
wherein the first connection region is defined by an end-sided inner surface of a silicone tube;
the second connection region is defined by an outer surface of a fluid connection stub; and
after exposure to the VUV radiation, the silicone tube is advanced over the fluid connection stub such that the first and second silicone connection regions contact one another.

23. The method of claim 22, wherein the fluid connection stub has an outer diameter greater than an inner diameter of the silicone tube.

24. The method of claim 22, wherein the end-sided inner surface of the silicone tube is exposed to the VUV radiation through an interior space of the silicone tube.

25. The method of claim 22, wherein the connection regions are brought into contact after exposure to the VUV radiation or during exposure to the VUV radiation.

26. The method of claim 22, wherein exposure to the VUV radiation is performed in an oxygen-free environment.

27. The method of claim 22, wherein at least one of the connection regions is elastically or plastically deformed before, during, or after exposure to the VUV radiation.
